(19) United States
(12) Patent Application Publication
(10) Pub. No.: US 2008/0224554 A1
(43) Pub. Date: Sep. 18, 2008

(54) BEARING ASSEMBLY AND MOTOR USING THE BEARING ASSEMBLY

(75) Inventors: Takahiro HIWA, Kyoto (JP); Hisashi FUJIHARA, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Minami-ku (JP)

(21) Appl. No.: 12/047,491

(22) Filed: Mar. 13, 2008

(30) Foreign Application Priority Data
Mar. 14, 2007 (JP) 2007-064964

(51) Int. Cl. H02K 5/16; F16C 43/04

(52) U.S. Cl. 310/90; 384/561

(57) ABSTRACT

In a bearing assembly, a shaft is inserted into a sleeve, and a lower end of the shaft is attracted to a magnet chip which is held by an auxiliary yoke. A retaining member and an auxiliary washer are sandwiched between a lower end surface of the sleeve and a contact portion of the auxiliary yoke so as to retain the shaft in the sleeve. The auxiliary washer has an inner diameter larger than that of the retaining member and a maximum diameter of the lower end of the shaft.

### BACKGROUND OF THE INVENTION

1. Field of the Invention

The present invention relates to a bearing assembly and an electric motor including the bearing assembly.

2. Description of the Related Art

As described in JP-A-06-294441 and JP-A-05-312233, a motor is used in a hydraulic damper of a vehicle in order to control the opening and closing of a valve to allow oil to flow therethrough, and to absorb external vibrations by vibrating a vibration plate which is in contact with the oil. Such a motor is required to be usable in an environment where shocks or vibrations are applied thereto.

There have been conventionally proposed various techniques for preventing disengagement of a shaft from a bearing member. Among these, there is a particular technique to achieve retention of the shaft by engaging with the shaft an annular retaining member which is in contact with one end of the bearing member.

A wide variety of shapes and materials are used to design bearing members. For example, a bottom end of a bearing member may be made thinner than the other end, or the bearing member may be made of a fragile material. In such cases, a retaining member may not be able to adequately retain the shaft, or a foreign object may be generated from the bearing member.

### SUMMARY OF THE INVENTION

In order to overcome the problems described above, a bearing assembly according to a preferred embodiment of the present invention preferably includes a shaft disposed coaxially with a central axis, a bearing member allowing the shaft to be inserted thereinto and having a bearing surface to rotatably support the shaft, a plate shaped retaining member having a substantially circular arcuate shape or a substantially annular shape arranged to engage with the shaft which axially projects from the bearing member toward an end of the bearing member during insertion or removal of the shaft, an auxiliary washer having a substantially circular arcuate shape or a substantially annular shape and an inner diameter larger than that of the retaining member, the auxiliary washer being disposed axially between the bearing member and the retaining member and being in contact with a surface of the retaining member on the bearing member side, and a contact portion having an inner diameter larger than that of the auxiliary washer and being in contact with the retaining member on a surface opposite to the surface facing the bearing member. Preferably, there is an annular groove in the shaft along an outer periphery thereof at a portion facing the retaining member.

The retaining member preferably has a support portion in contact with the contact portion, and an engaging portion which projects inwards from the support portion and into the annular groove but does not contact the shaft when the shaft is fully inserted into the bearing member. The inner diameter of the auxiliary washer is preferably larger than an outer diameter of an outer peripheral surface of the shaft at a portion that is inserted through the auxiliary washer.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a pattern cross-sectional view of a motor, cut along an axial direction, according to a first preferred embodiment of the present invention.

FIG. 2 is an enlarged view of a lower portion of a bearing assembly according to a preferred embodiment of the present invention.

FIG. 3 is a plan view of a retaining member according to a preferred embodiment of the present invention.

FIG. 4 is a pattern view of the retaining member according to a preferred embodiment of the present invention being attached to a lower end of a shaft.

FIG. 5 is a pattern view of the retaining member being applied with a force to pull the shaft out of a sleeve.

FIG. 6 is a table indicating values of press fitting forces and retaining intensities according to a preferred embodiment of the present invention and comparative examples.

FIG. 7 is an enlarged pattern view of a lower portion of a bearing assembly according to a second preferred embodiment of the present invention.

FIG. 8 is an enlarged pattern view of a lower portion of a bearing assembly according to an example of preferred embodiments of the present invention.

FIG. 9 is a plan view of a retaining member according to another example of preferred embodiments of the present invention.

FIG. 10 is a plan view of a retaining member according to still another example of preferred embodiments of the present invention.

FIG. 11 is a plan view of a retaining member according to still another example of preferred embodiments of the present invention.

### DETAILED DESCRIPTION OF PREFERRED EMBODIMENTS

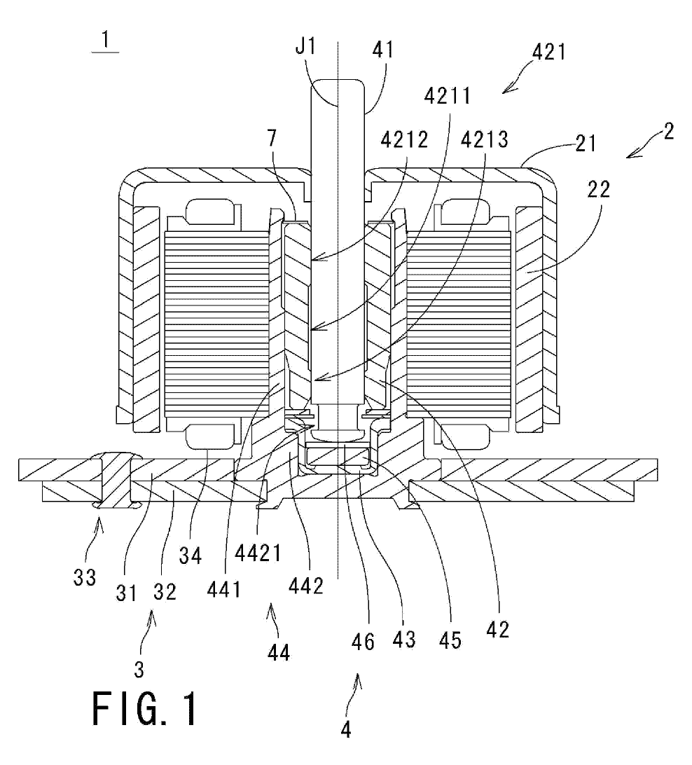

Referring to FIGS. 1 through 11, preferred embodiments of the present invention will be described in detail. It should be noted that in the explanation of the preferred embodiments of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction substantially parallel to a rotation axis, and a radial direction indicates a direction substantially perpendicular to the rotation axis.

### First Preferred Embodiment

FIG. 1 is a pattern cross-sectional view of an electric motor 1, cut along an axial direction, according to a first preferred embodiment of the present invention. The motor 1 is preferably mounted in a hydraulic damper to absorb vibrations from an engine of a vehicle or the like. A shaft 41, which is to be described below, is attached at a predetermined position such that the shaft 41 is preferably arranged substantially parallel to a direction of vibrations transmitted from the engine. The motor 1 changes a width of an oil passage so as to regulate a frequency band to absorb vibrations of the hydraulic damper and changes the vibration absorption properties such as the degree of absorption. The motor 1 also absorbs vibrations by pressing the oil.

The motor 1 is preferably an outer rotor type. The motor 1 includes a rotor portion 2 serving as a rotating assembly, a stator portion 3 serving as a stator assembly, and a bearing assembly 4 supporting the rotor portion 2 in a rotatable manner relative to the stator portion 3. In the following description, an assumption is made such that the rotor portion 2 is positioned on an upper side and the stator portion 3 is positioned on a lower side along a central axis J1 for convenience sake. But the central axis J1 is not necessarily aligned along the direction of a gravitational force.

The rotor portion 2 preferably includes a rotor hub 21 having a lid portion allowing an upper end of the shaft 41 in the bearing assembly 4 to be fixed at a center thereof and a cylindrical portion extending axially downwards from an outer peripheral edge of the lid portion, and a field magnet 22 attached to an inner peripheral surface of the cylindrical portion of the rotor hub 21. The stator portion 3 preferably includes a circuit board 31 and a support plate 32 each having an opening at a center thereof, and armatures 34 arranged to surround the bearing assembly 4. Attached to the center of the support plate 32 is a sleeve holder 44 serving as a bearing support member to be described below. The circuit board 31 is preferably fixed to the support plate 32 with a rivet 33. The shaft 41 may be regarded as a portion of the rotor portion 2, and the sleeve holder 44 may be regarded as a portion of the stator portion 3.

The bearing assembly 4 preferably includes the shaft 41 made of stainless steel or the like, a sleeve 42 serving as a bearing member to allow the shaft 41 to be inserted therein, an auxiliary yoke 43 arranged below the sleeve 42, a magnet chip 45, a thrust member 46 (hereinafter, referred to as a “thrust plate”), and the sleeve holder 44 serving as a bearing support member to cover the sleeve 42 and the auxiliary yoke 43. The shaft 41 is preferably magnetic. The sleeve holder 44 has a portion having a cylindrical shape (hereinafter, referred to as a “cylindrical portion 441”) to allow the sleeve 42 to be inserted therein, and a bottom portion 442 closing a lower side of the cylindrical portion 441. The cylindrical portion 441 and the bottom portion 442 are preferably a single member. There is provided inside the bottom portion 442 a concave portion 4421 surrounding the central axis J1. The auxiliary yoke 43 is attached to the concave portion 4421. The sleeve 42 is fixed to an inner peripheral surface of the cylindrical portion 441, while the armatures 34 are fixed to an outer peripheral surface thereof. The armatures 34 are arranged so as to radially face the field magnet 22. Interaction between the armatures 34 and the field magnet 22 causes torque about the central axis J1, so that the motor 1 rotates about the central axis J1.

The magnet chip 45 has a circular disc shape and is arranged within the concave portion 4421 at the bottom portion 442 of the sleeve holder 44. The magnet chip 45 is held onto the auxiliary yoke 43 which has a cylindrical portion and a bottom portion covering a lower end of the cylindrical portion. Both an outer peripheral surface and a lower surface of the magnet chip 45 are surrounded by the auxiliary yoke 43. The auxiliary yoke 43 is preferably formed by pressing a magnetic metal plate. Disposed on an upper surface of the magnet chip 45 is the thrust plate 46 preferably made of a resin or plastic material and having a flat plate shape. Since the magnet chip 45 magnetically attracts a lower end of the shaft 41 which projects downwards from the sleeve 42, the thrust plate 46 is maintained in position while being in contact with the lower end of the shaft 41. Thus, the shaft 41 may be easily biased downwards by utilizing the magnet chip 45 and the auxiliary yoke 43. The thrust plate 46 is preferably made of a resin or plastic material such as polyether ether ketone (PEEK).

The sleeve 42 is preferably a porous member impregnated with lubricant oil. The sleeve 42 has a concave portion 4211 at approximately the center of an inner peripheral surface 421 in the central axis J1 direction. Provided respectively on upper and lower sides of the concave portion 4211 are sliding contact portions 4212 and 4213, each of which functions as a bearing surface to maintain an outer peripheral surface of the shaft 41 and the inner peripheral surface 421 of the sleeve 42 smoothly slidable with respect to each other. The concave portion 4211 is arranged to have an inner diameter larger than an inner diameter of each of the sliding contact portions 4212 and 4213. The sliding contact portions 4212 and 4213 respectively face the outer peripheral surface of the shaft 41 while radially spaced apart therefrom by approximately 0.05 mm to approximately 0.1 mm, for example.

While the motor 1 is driven, the shaft 41 is rotatably supported in a direction substantially perpendicular to the central axis J1 (a radial direction) by the sliding contact portions 4212 and 4213 of the sleeve 42 via lubricant oil. The lower end of the shaft 41 is rotatably supported in the central axis J1 direction (a thrust direction) by the magnet chip 45 and the thrust plate 46 without the lower end of the shaft 41 being out of contact with the thrust plate 46. In particular, the shaft 41 is magnetically attracted downwards by the magnet chip 45. Such a configuration achieves stable rotation of the motor 1. Further, there is attached a washer 7 having an annular shape on an upper end surface of the sleeve 42. The washer 7 can prevent the lubricant oil impregnated in the sleeve 42 from dispersing from the upper end surface of the sleeve 42.

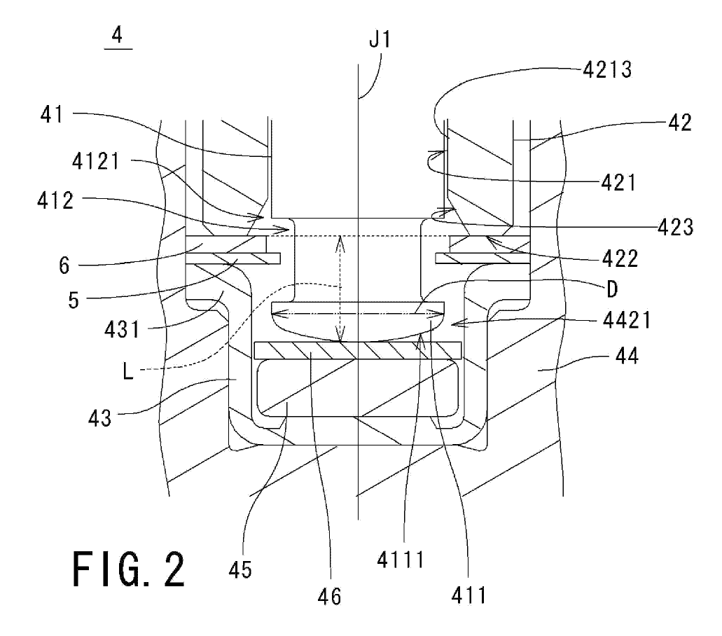

FIG. 2 is an enlarged pattern view of a lower portion of the bearing assembly 4. At a lower end 411 of the shaft 41, a surface 4111 in contact with the thrust plate 46 is preferably shaped to have a semi-spherical surface. While the rotor portion 2 (see FIG. 1) is rotating, the shaft 41 is supported in the thrust direction, as described above, at the center of the surface 4111, so that a pivot bearing is established. In other words, the lower end 411 functions as an axial support portion. In the vicinity of the lower end 411, an annular groove 412 is arranged along an outer periphery of the shaft 41 (that is, around the central axis J1). A corner portion 4121 of the annular groove 412 close to the inner peripheral surface 421 of the sleeve 42 is positioned between the sliding contact portion 4213 on the inner peripheral surface 421 and a lower end surface 422 of the sleeve 42. Further, on the lower side of the inner peripheral surface 421 of the sleeve 42, there is provided an inclined surface 423 such that the inner diameter of the sleeve 42 gradually increases toward the lower end surface 422. The corner portion 4121 radially faces the inclined surface 423. The inclined surface 423 connects the lower end surface 422 to the inner peripheral surface 421 while being inclined toward the central axis J1 as it extends upward, as shown in FIG. 2. The inclined surface 423 and the central axis J1 preferably define an acute angle of about 30° to about 45°, for example.

A retaining member 5 and an auxiliary washer 6 each preferably having an annular shape are arranged axially between the sleeve 42 and the auxiliary yoke 43 which holds the magnet chip 45. Each of the retaining member 5 and the auxiliary washer 6 radially faces a bottom surface (a surface substantially parallel with the central axis J1) of the annular groove 412 of the shaft 41. The auxiliary washer 6 is in contact with an upper surface (a surface facing the sleeve 42) of the retaining member 5. The retaining member 5 is preferably thinner than the auxiliary washer 6. The auxiliary washer 6 is preferably designed to have an inner diameter slightly larger than an inner diameter of the sliding contact portion 4213 of the sleeve 42, and smaller than an inner diameter of the lower end surface 422 of the sleeve 42 (which inner diameter corresponds to the inner diameter of the end surface facing the auxiliary washer 6, and also the maximum diameter of the inclined surface 423). The inner diameter of the auxiliary washer 6 is preferably larger than that of the retaining member 5.

An upper end contact portion 431 of the auxiliary yoke 43, which faces the retaining member 5, includes on an upper surface thereof an annular planar surface extending radially outwards. The contact portion 431 functions as an annular contact portion which is in contact with an outer edge of the lower surface (a surface on the opposite side of the sleeve 42) of the retaining member 5. The contact portion 431 is preferably arranged to have an inner diameter (to be precise, an inner diameter of an area in the contact portion 431 shown in FIG. 2 in contact with the retaining member 5) larger than that of the auxiliary washer 6. Further, the maximum outer diameter of the shaft 41 is preferably larger than the inner diameter of the retaining member 5 and smaller than the inner diameter of the auxiliary washer 6. In a state where the shaft 41 is inserted in the concave portion 4421 which is provided in the cylindrical portion of the auxiliary yoke 43 and the upper surface of the thrust plate 46, only the inner peripheral portion of the retaining member 5 is positioned inside the annular groove 412 of the shaft 41. It is noted that the inner diameter of the auxiliary washer 6 is not necessarily larger than the maximum diameter of the shaft 41. As shown in FIG. 2, a portion L of the shaft 41 to be inserted through the auxiliary washer 6 only has to have a maximum diameter D which is larger than the inner diameter of the retaining member 5 and not larger than the inner diameter of the auxiliary washer 6.

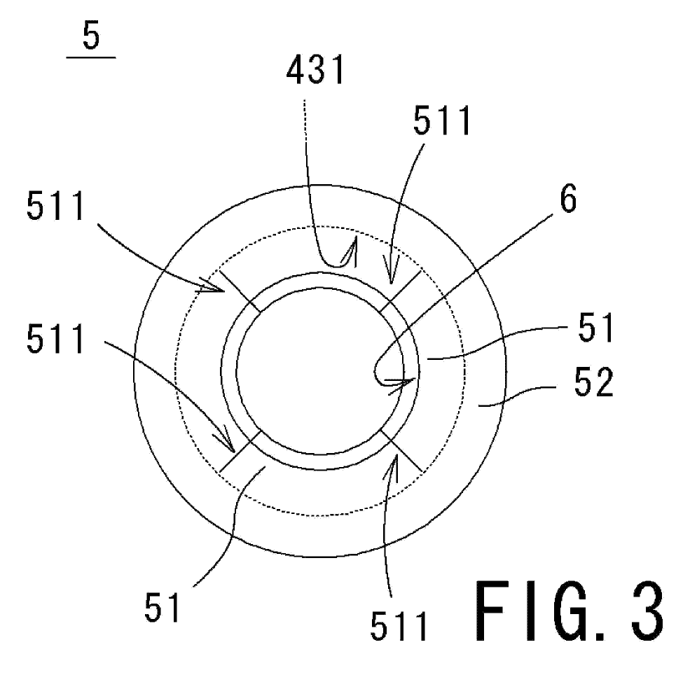

FIG. 3 is a plan view of the retaining member 5. There are shown in FIG. 3, as well as the retaining member 5, the contact portion 431 of the auxiliary yoke 43 in contact with the lower surface of the retaining member 5 by a dashed line. There is also shown, by a chain double-dashed line, the auxiliary washer 6 in contact with the upper surface of the retaining member 5.

The retaining member 5 is preferably made of a resin or plastic material such as polyester, which is excellent in elasticity, and preferably has an annular plate shape. Similarly, the auxiliary washer 6 is made of a resin or plastic material such as polyester, and preferably has an annular plate shape. The auxiliary washer 6 is preferably more rigid rather than the retaining member 5. In order to do so, the auxiliary washer 6 may be thicker than the retaining member 5, or the auxiliary washer 6 may be made of a rigid material, such as metal. When the auxiliary washer 6 is made of a metal material, rigidity of the auxiliary washer 6 may be easily achieved.

Four slits 511 are arranged to each extend radially outwards from the inner peripheral edge of the retaining member 5. The slits 511 respectively extend to a position corresponding to the inner periphery of the contact portion 431, and are preferably equally spaced apart from one another in the circumferential direction around the central axis J1. Inner peripheral ends of a plurality of engaging portions 51, which are formed between the respective slits 511, project into the annular groove 412 of the shaft 41 shown in FIG. 2. An entire periphery of an annular support portion 52 on the outer peripheral side, where the slits 511 are not provided, is sandwiched between the contact portion 431 and the auxiliary washer 6. Thus, the annular support portion 52 is in contact with the contact portion 431 and functions as an annular support portion which supports the engaging portions 51. Each of the engaging portions 51 projects inwards from the annular support portion 52, a portion of which functions as a portion to project into the annular groove 412 (see FIG. 2) of the shaft 41. On the upper surface of the retaining member 5, the auxiliary washer 6 is in contact with a portion of each of the engaging portions 51 as well as the annular support portion 52. The retaining member 5 may be easily manufactured when the engaging portions 51 are provided with the slits 511. Each of the slits 511 is formed by cutting a portion of the retaining member 5 radially outwards from the inner peripheral edge. Therefore, a circumferential width of each of the slits 511 is extremely small.

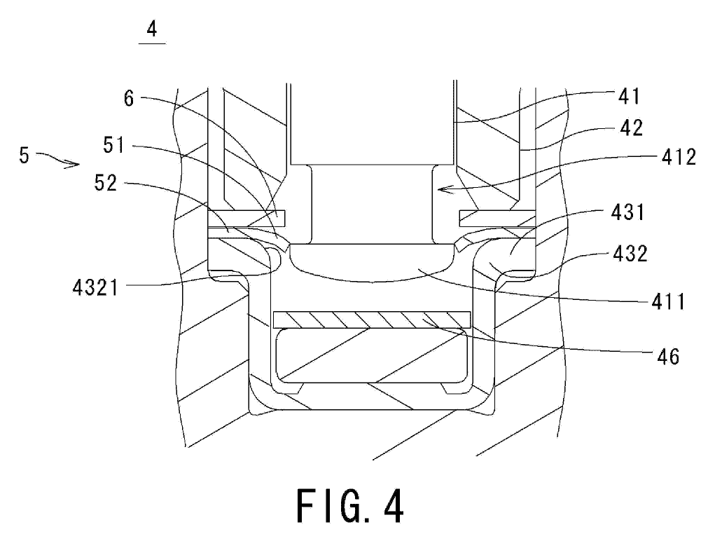

FIG. 4 is a view showing a state where, during manufacture of the bearing assembly 4, the lower end 411 of the shaft 41 is inserted through the sleeve 42 to be engaged with the retaining member 5. When the lower end 411 of the shaft 41 is inserted through the retaining member 5, the peripheral edge of the lower end 411 of the shaft 41 is first brought into contact with inner peripheral ends of the engaging portions 51 of the retaining member 5. The engaging portions 51 are then supported by the annular support portion 52 and are bent and pressed downwards with the inner peripheral edge of the contact portion 431 serving as a support point. According to such a configuration, an adequate length of each of the slits 511 (see FIG. 3) of the engaging portions 51 may be secured, and the shaft 41 may be easily inserted without requiring a strong force since the shaft 41 is not brought into contact with the auxiliary washer 6. Thereafter, the lower end 411 of the shaft 41 passes through the engaging portions 51 immediately before the lower end 411 is brought into contact with the thrust plate 46. As a result, the engaging portions 51 project into the annular groove 412 when the shaft 41 is fully inserted into the sleeve 42, but do not contact the shaft 41.

A bent portion 432 is arranged between the cylindrical portion and the contact portion 431 of the auxiliary yoke 43. Further, a curved surface 4321 is provided between the inner peripheral surface of the cylindrical portion and the upper surface of the contact portion 431. According to such a configuration, it is possible to shift radially outwards an inner peripheral edge of a contact area between the annular support portion 52 of the retaining member 5 and the contact portion 431. Moreover, provision of the curved surface 4321 enables the engaging portions 51 of the retaining member 5 to be bent downwards with no sharp contact with the curved surface 4321. As a result, the shaft 41 may be easily inserted through the retaining member 5. Since the auxiliary yoke 43 is preferably formed by pressing, the bent portion 432 is formed simultaneously when the contact portion 431 is formed by bending radially outwards the upper portion of the cylindrical portion. Thus, the bent portion 432 may be easily formed.

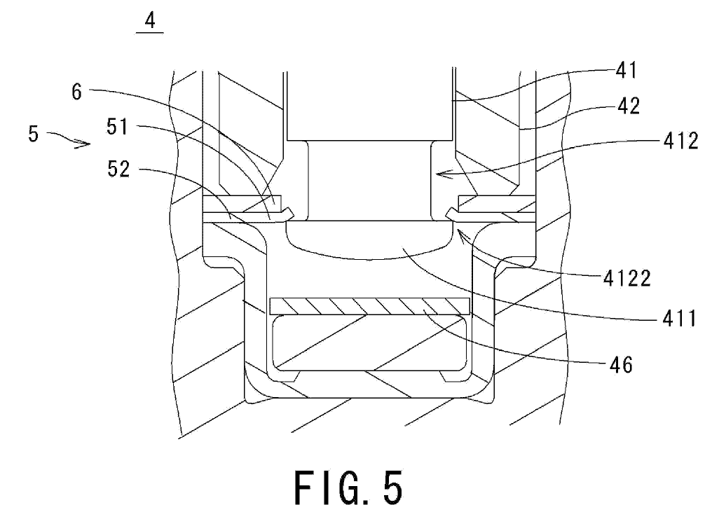

FIG. 5 is a view showing a state where the shaft 41 is applied with a force to pull the shaft 41 out of the sleeve 42. As the shaft 41 separates from the thrust plate 46 to move upwards, a corner portion 4122 on the lower side of the annular groove 412 of the shaft 41 is brought into contact with the inner peripheral ends of the engaging portions 51 of the retaining member 5. Because of such contact, the inner peripheral ends of the engaging portions 51 are pressed upwards. At this time, the retaining member 5 is bent with the inner peripheral edge of the auxiliary washer 6 serving as a support point. However, since the distance is short from the inner peripheral ends of the engaging portions 51 to the inner peripheral edge of the auxiliary washer 6, the engaging portions 51 are brought into contact with a lower edge of the annular groove 412 and deformation of the engaging portions 51 is prevented by the auxiliary washer 6. According to such a configuration, the shaft 41 is prevented from being pulled out of the sleeve 42 (that is, a strong force is required to pull out the shaft 41).

As described above, there is established in the bearing assembly 4 a retention mechanism for easily inserting the shaft 41 through the retaining member 5 while not allowing the shaft 41 to be easily pulled out.

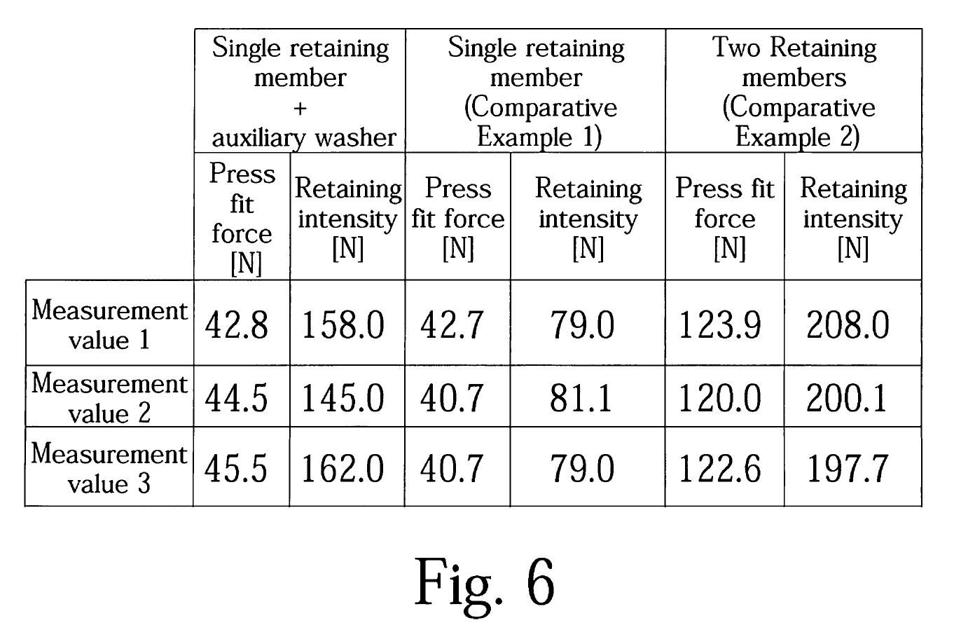

FIG. 6 is a table indicating values of forces required to insert the shaft 41 (hereinafter, referred to as “press fit forces”) and values of forces required to pull out the shaft 41 (hereinafter, referred to as “retaining intensities”) in the retention mechanism of the bearing assembly 4, as well as values of press fit forces and retaining intensities in two different retention mechanisms according to comparative examples. In Comparative Example 1, there is provided only one retaining member 5 similar to that of the bearing assembly 4 without providing the auxiliary washer 6 shown in FIG. 2. In Comparative Example 2, there are layered two retaining members 5 without providing the auxiliary washer 6.

As apparent from measurement values 1 to 3 obtained in three different measurements, the present preferred embodiment and Comparative Example 1 exert substantially the same press fit forces. Comparative Example 2 exerts a press fit force having a value approximately three times of that of the present preferred embodiment. In Comparative Example 2, when the shaft 41 is inserted by a strong force, the shaft 41 is brought into strong contact with the thrust plate 46, which may cause damage to the thrust plate 46 or the magnet chip 45. With regard to the retaining intensities of the measurement values 1 to 3, Comparative Example 2 exerts the largest retaining intensity, the present preferred embodiment exerting the second largest, and Comparative Example 1 exerts the smallest retaining intensity. Further, the present preferred embodiment exerts the retaining intensity of a value approximately twice of that of Comparative Example 1, which means that the retaining intensity of the present preferred embodiment is adequately large in comparison with Comparative Example 1. Thus, the present preferred embodiment may minimize the press fit force so as not to exceed a predetermined limit, and may also secure the retaining intensity so as not to be less than a predetermined tolerance in accordance with the factor of safety. As a result, it is possible to secure the reliability of the motor.

There have been described the motor 1, and in particular, the retention mechanism of the bearing assembly 4. According to the retention mechanism of the bearing assembly 4, the engaging portions 51 of the retaining member 5 may be adequately bent downwards, but are also restricted from being bent upwards by the auxiliary washer 6. Therefore, the shaft 41 and the retaining member 5 may be engaged with each other by a little force, and the shaft 41 may be prevented from being pulled out of the sleeve 42. Further, the shaft 41 may be easily inserted even when the thrust plate 46, made of a resin or plastic material, and the magnet chip 45 are disposed under the lower end 411 of the shaft 41. Therefore, it is possible to prevent damage to the thrust plate 46 or the magnet chip 45 due to strong contact between the lower end 411 of the shaft 41 and the thrust plate 46 during insertion of the shaft 41.

Further, the auxiliary washer 6 can adequately restrict the engaging portions 51 of the retaining member 5 from being bent upwards, irrespective of the shape of the lower end surface 422 of the sleeve 42. Accordingly, even in a case where the shaft 41 is applied with a force to pull out the same (an axially upward force) and a lower edge of the annular groove 412 is brought into strong contact with the engaging portions 51 of the retaining member 5, the auxiliary washer 6 prevents the application of a strong force to the sleeve 42. Therefore, the retention mechanism may be established irrespective of the material of the sleeve 42.

As shown in FIG. 2, since the lower end 411 of the shaft 41 is supported at the center of the surface 4111, it is impossible to form a support hole at the center of the surface 4111 in order to grind the shaft 41. Instead, the shaft 41 is preferably ground during manufacture thereof by sandwiching the outer peripheral surface thereof with grind stone rollers to apply centerless grinding. In such a case, since grinding is not applied to the inner portion of the annular groove 412, a burr or the like may be generated at the corner portion 4121 (see FIG. 2) of the annular groove 412. However, in the bearing assembly 4, as the corner portion 4121 faces the inclined surface 423 of the sleeve 42 with a space therebetween, it is possible to prevent damage to the inner peripheral surface 421 (in particular, the sliding contact portion 4213) of the sleeve 42 by burrs or another small projections even when the shaft 41 is applied with a force to incline the shaft 41. Further, even when a centrifugal force generated by rotation of the rotor portion 2 causes burrs to be deformed radially outwards, it is possible to prevent damage to the inner peripheral surface 421 (in particular, the sliding contact portion 4213) of the sleeve 42. In addition, the height of the bearing assembly 4 may be reduced by provision of the inclined surface 423, in comparison with a case where the corner portion 4121 of the annular groove 412 is positioned below the lower end surface 422 of the sleeve 42.

### Second Preferred Embodiment

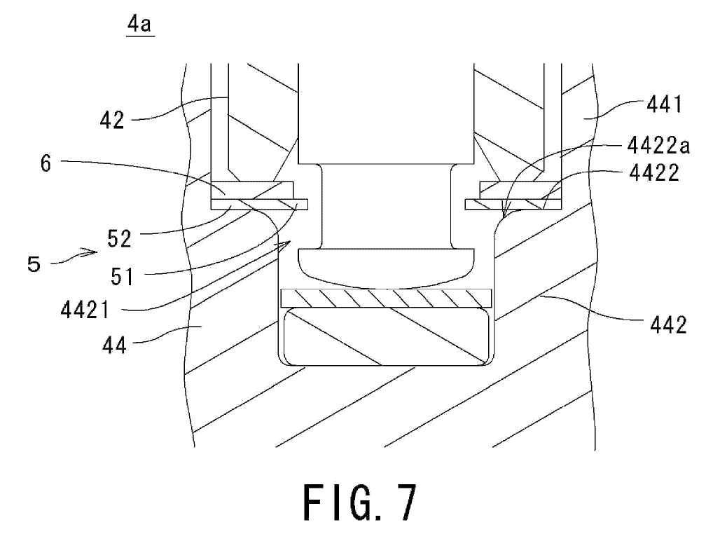

FIG. 7 is an enlarged pattern view of a lower portion of a bearing assembly 4a in a motor according to a second preferred embodiment, and is similar to FIG. 2. In the bearing assembly 4a, there is provided no auxiliary yoke 43 in the bearing assembly 4 according to the first preferred embodiment. In the bearing assembly 4a, a portion of the retaining member 5 is in contact with an annular planar surface 4422 surrounding the concave portion 4421 which is provided in the bottom portion 442 of the sleeve holder 44. The retaining member 5 and the auxiliary washer 6 are sandwiched between the sleeve 42 and the planar surface 4422. The remaining components of the bearing assembly 4a are similar to those of the bearing assembly 4, which are designated by the same symbols.

An outer peripheral edge of the planar surface 4422 coincides with the lower end of the inner peripheral surface of the cylindrical portion 441. The planar surface 4422 functions as a contact portion which is in contact with the outer peripheral edge of the retaining member 5. The slits 511 (see FIG. 3) of the retaining member 5 are arranged to reach the inner periphery of the planar surface 4422. Similarly to the first preferred embodiment, portions between each of the slits 511 of the retaining member 5 function as the engaging portions 51 that project into the annular groove 412 of the shaft 41. An entire outer peripheral portion not provided with the slits 511 is in contact with the planar surface 4422 and functions as the annular support portion 52 which supports the engaging portions 51.

A curved surface 4422a is provided to connect the planar surface 4422 and the inner peripheral surface of the concave portion 4421. The curved surface 4422a may be replaced with an annular inclined surface, of which diameter gradually increases towards the upper side. The curved surface 4422a exerts effects similar to those of the curved surface 4321 (see FIG. 4) at the bent portion 432 of the auxiliary yoke 43 according to the first preferred embodiment.

The planar surface 4422 has an inner diameter larger than that of the auxiliary washer 6. When the shaft 41 is inserted into the concave portion 4421, the engaging portions 51 may be adequately bent with a support point of the inner peripheral edge of the planar surface 4422, which functions as a contact portion. Accordingly, the shaft 41 may be easily inserted through the retaining member 5. When the shaft 41 is applied with a force to pull the same out of the sleeve 42 (specifically, an axially upward force), the engaging portions 51 are bent only slightly with the inner peripheral edge of the auxiliary washer 6 serving as a support point, thereby restricting deformation of the engaging portions 51. According to such a configuration, the shaft 41 and the retaining member 5 may be engaged with each other by a weak force, and the shaft 41 may be prevented from being pulled out of the sleeve 42. Further, as the planar surface 4422 of the sleeve holder 44 includes the contact portion, the retention mechanism may be provided with a smaller number of members, resulting in a simplified structure of the bearing assembly.

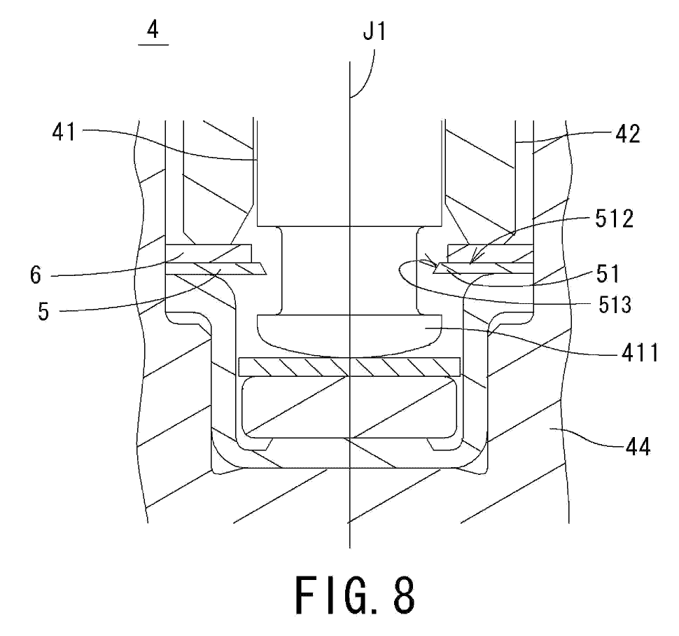

FIG. 8 is a view showing an example of the bearing assembly 4 of FIG. 2 provided with a retaining member 5 having a different shape. In the retaining member 5 shown in FIG. 8, each of the engaging portions 51 has at the inner peripheral end thereof an inner peripheral end inclined surface 513 such that the surface 513 is inclined gradually away from the central axis J1 as it becomes closer to the auxiliary washer 6. The inner peripheral end inclined surface 513 is not required to be formed on the entire inner peripheral end of each of the engaging portions 51 as long as the inclined surface 513 is formed continuously from an upper surface 512 in contact with the auxiliary washer 6. For example, there may be partially provided a small inclined surface on the upper side of the inner peripheral surface of each of the engaging portions 51 so as to intervene between the inner peripheral surface and the upper surface 512. When the inner peripheral end inclined surface 513 is provided at each of the engaging portions 51, the lower end 411 of the shaft 41 may be inserted through the retaining member 5 more smoothly.

In order not to decrease the retaining intensity of the shaft 41, a boundary between the upper surface 512 and the inner peripheral end inclined surface 513 of the engaging portion 51 is preferably either at substantially the same position in the radial direction as the inner peripheral edge of the auxiliary washer 6, or at a position closer to the central axis J1 with respect to the inner peripheral edge of the auxiliary washer 6. According to such a configuration, the shaft 41 may be inserted through the retaining member 5 more smoothly.

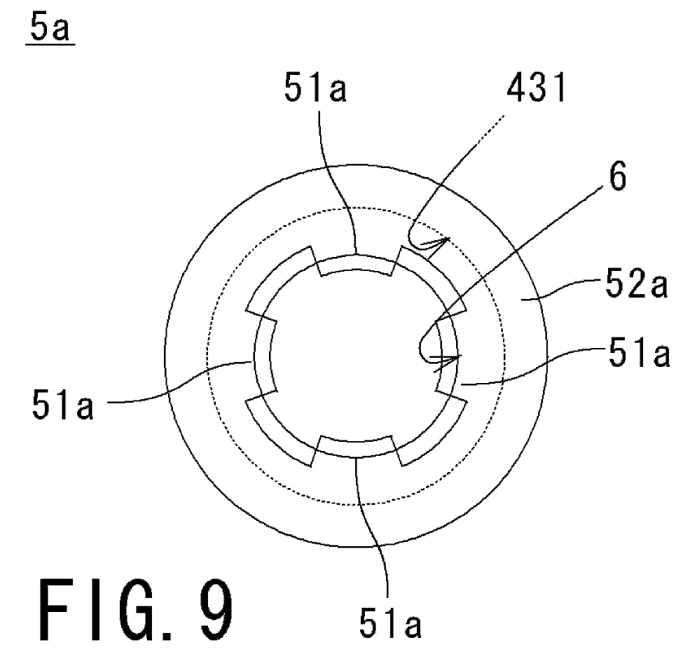

FIG. 9 is a plan view showing another example of the retaining member. In FIG. 9, there are shown, as well as a retaining member 5a, the contact portion 431 of the auxiliary yoke 43 in contact with a lower surface of the retaining member 5a by dashed line. There is also shown the auxiliary washer 6 in contact with an upper surface of the retaining member 5a by a chain double-dashed line. A bearing assembly provided with the retaining member 5a is configured similarly to the bearing assembly 4 according to the first preferred embodiment, apart from the retaining member 5a.

The retaining member 5a includes an annular support portion 52a in contact with the contact portion 431 and the auxiliary washer 6, and four engaging portions 51a each projecting inwards from the annular support portion 52a to project into the annular groove 412 (see FIG. 2) of the shaft 41. The engaging portions 51a are each provided in the shape of a projection, and are aligned along the circumferential direction and preferably equally spaced apart from each other.

The inner diameter of the auxiliary washer 6 is larger than a diameter of a circle obtained by connecting inner peripheral ends of the four engaging portions 51a (which is substantially regarded as an inner diameter of the retaining member 5a), and is smaller than the inner diameter of the contact portion 431. According to such a configuration, the engaging portions 51a may be adequately bent when the shaft 41 is inserted therethrough in a manner similar to the first preferred embodiment. When the shaft 41 is applied with a force to pull the shaft 41 out of the sleeve 42 (specifically, a radially upward force), deformation of the engaging portions 51a is prevented by the auxiliary washer 6, so that the shaft 41 and the retaining member 5a may be engaged with each other by a weak force and the shaft 41 may be prevented from being pulled out of the sleeve 42.

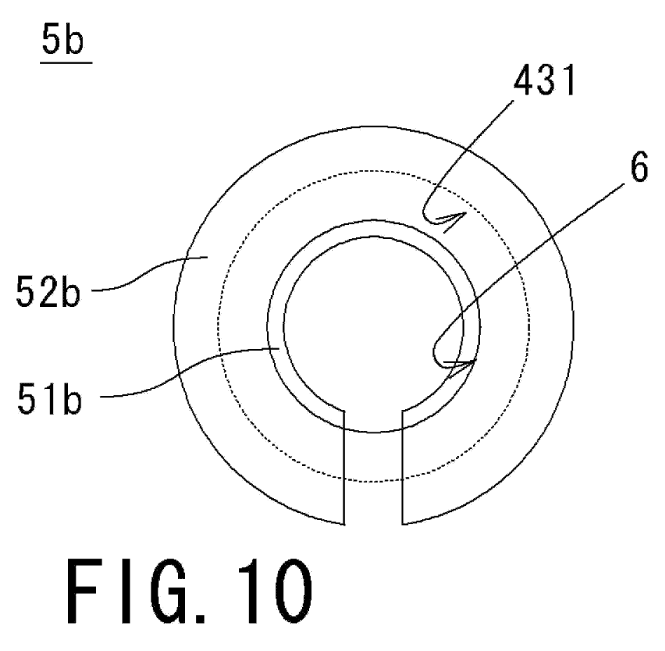

FIG. 10 is a plan view showing still another example of a retaining member. Similarly to FIGS. 3 and 9, there are shown, as well as a retaining member 5b, the contact portion 431 by a dashed line and the auxiliary washer 6 by a chain double-dashed line. The retaining member 5b is not provided with slits 511, which are provided in the retaining member 5 according to the first preferred embodiment, but preferably has a substantially C-shaped configuration with a partial cutout crossing from an inner peripheral end to an outer peripheral end.

A support portion 52b in the retaining member 5b in contact with the contact portion 431 has a partial cutout and is continuous from an engaging portion 51b which is positioned radially inside the portion 52b to function as a support portion to substantially support the engaging portion 51b. The engaging portion 51b functions as a portion to be engaged, at an inner peripheral edge thereof, with the annular groove 412 of the shaft 41 during insertion or removal of the shaft 41.

Similarly to the first preferred embodiment, the inner diameter of the auxiliary washer 6 is larger than an inner diameter of the retaining member 5b, and is smaller than the inner diameter of the contact portion 431. The contact portion 431 is brought into contact with the support portion 52b, and the auxiliary washer 6 is brought into contact with the support portion 52b and a portion of the engaging portion 51b. According to such a configuration, when the shaft 41 is inserted, the engaging portion 51b may be adequately bent with the inner peripheral edge of the contact portion 431 serving as a support point. Further, when the shaft 41 is applied with a force to pull the shaft 41 out of the sleeve 42 (specifically, an axially upward force), deformation of the engaging portion 51b is prevented by the auxiliary washer 6.

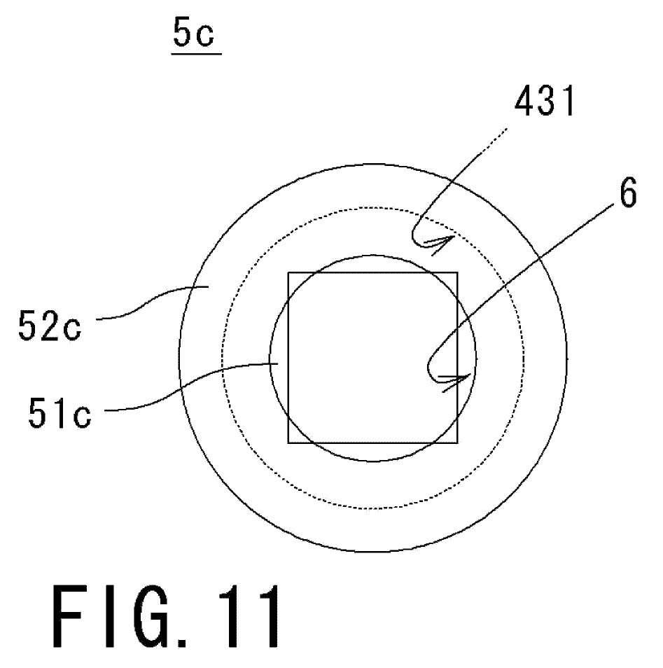

While preferred embodiments of the present invention have been described above, the present invention is not limited thereto but various modifications are possible to be made. For example, as shown in FIG. 11, a retaining member 5c may be used which is provided with a rectangular opening at a center thereof. In FIG. 11, similarly to FIG. 3, there are shown the contact portion 431 and the auxiliary washer 6. In the retaining member 5c, a portion in contact with the contact portion 431 functions as an annular support portion 52c which supports an inner portion thereof. The portion inside the annular support portion 52c functions as an engaging portion 51c which project into the annular groove 412 of the shaft 41 shown in FIG. 2. Although the engaging portion 51c has straight inner corners, each of the sides of the rectangular opening may be regarded as projecting towards the central axis J1 since a center of each of the sides is closer to the central axis J1. Similarly to the first preferred embodiment, the inner diameter of the auxiliary washer 6 is larger than an inner diameter of the retaining member 5c and smaller than the inner diameter of the contact portion 431. The engaging portion 51c may be adequately bent downwards but upward deformation thereof is prevented.

While the retaining member 5 is provided with four slits 511 in the first preferred embodiment, the number of the slits 511 is not limited thereto. Similarly, the number of the engaging portions 51a is not limited to four in the example shown in FIG. 9.

In the above preferred embodiments, the sleeve holder 44 may not be a single member. Alternatively, the sleeve holder 44 may be configured with a cylindrical member and a cap member which is attached to the cylindrical member. Further alternatively, the sleeve holder 44 and the support plate 32 may be a single member.

The sleeve 42 may not be brought into contact with the auxiliary washer 6, but another member may intervene between the sleeve 42 and the auxiliary washer 6. The auxiliary washer 6 may be fixed to the sleeve holder 44 by a different method. There may be disposed on the lower surface of the retaining member an annular member having an inner diameter larger than the inner diameter of the auxiliary washer 6, so that the annular member is utilized as a contact portion.

In the above preferred embodiments, the magnet chip 45 is disposed on the bottom portion 442 of the sleeve holder 44, but the rotor portion 2 may be biased toward the stator portion 3 by a different method. In the above preferred embodiments, a slide bearing utilizing lubricant oil is preferably used as the bearing assembly, the technique of the retention mechanism according to the various preferred embodiments is applicable to other types of slide bearings such as a magnetic bearing and a pneumatic bearing.

The motor 1 according to the above preferred embodiments is preferably used in a hydraulic damper of an engine of a vehicle. A motor provided with the retention mechanism according to the various preferred embodiments may be suitably mounted in other equipment which is used in an environment where vibrations and shocks are applied.

While the sleeve holder 44 serving as a bearing support member in the various preferred embodiments of the present invention has the cylindrical portion 441, the sleeve holder of the present invention is not limited thereto, but may have a polygonal tube portion in top plan view, as long as it has a tube like portion.

Although the auxiliary yoke 43 according to the various preferred embodiments of the present invention has a cylindrical portion, the auxiliary yoke of the present invention is not limited thereto. The auxiliary yoke may have a polygonal tube portion in top plan view, as long as the auxiliary yoke has a tube like portion to accommodate a magnet chip. Although the auxiliary yoke 43 according to the various preferred embodiments of the present invention is provided with the bent portion 432 and the curved surface 4321, the auxiliary yoke of the present invention is not limited thereto. Any auxiliary yoke may be applicable as long as there is provided, between the cylindrical portion and the contact portion, no portion which would prevent the retaining member 5 from being bent downwards. Accordingly, there may be provided, in place of the bent portion, an annular inclined surface which diameter is gradually reduced toward the lower end. Further, the auxiliary yoke may be formed not only by pressing but also by cutting or molding.

According to the preferred embodiments of the present invention, the annular groove 412 of the shaft 41, the retaining member 5, and the auxiliary washer 6 are respectively arranged below the sleeve 42. However, the present invention is not limited thereto. Alternatively, the annular groove 412 of the shaft 41, the retaining member 5, and the auxiliary washer 6 may be respectively arranged above the sleeve 42.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A bearing assembly for use in a motor, comprising:
a shaft arranged coaxially with a center axis of the motor;
a bearing member arranged to allow the shaft to be inserted thereinto and having a bearing surface supporting the shaft in a rotatable manner;
a retaining member arranged to engage the shaft in the bearing member;
a washer arranged axially between the bearing member and the retaining member to be in contact with a bearing member side surface of the retaining member, and having an inner diameter larger than an inner diameter of the retaining member; and
a contact portion arranged to be in contact with a surface of the retaining member opposite to the bearing member and having an inner diameter larger than the inner diameter of the washer; wherein
an annular groove is provided in the shaft at a position opposing the retaining member along an outer periphery of the shaft;
the retaining member includes a support portion which is in contact with the contact portion, and at least one engaging portion arranged to extend into the annular groove but not contact the shaft when the shaft is fully inserted into the bearing member, and to engage the shaft during insertion or removal of the shaft from the bearing member; and
the inner diameter of the washer is larger than an outer diameter of a portion of the shaft inserted through the washer.

2. The bearing assembly according to claim 1, wherein the inner diameter of the washer is substantially the same as or larger than an inner diameter of the bearing surface of the bearing member.

3. The bearing assembly according to claim 1, wherein a thickness of the retaining member is less than a thickness of the washer.

4. The bearing assembly according to claim 1, wherein the washer is made of metal.

5. The bearing assembly according to claim 1, wherein the at least one engaging portion of the retaining member includes a plurality of engaging portions arranged at a plurality of positions in a circumferential direction.

6. The bearing assembly according to claim 1, wherein an inner side surface of the at least one engaging portion of the retaining member includes an inclined surface which is inclined with respect to the center axis such that the inclined surface becomes farther away from the center axis as it extends closer to the washer.

7. The bearing assembly according to claim 6, wherein a radially outermost portion of the inclined surface of the retaining member is arranged at substantially the same radial distance from the center axis as a radially inner edge of the washer, or is closer to the center axis than the radially inner edge of the washer.

8. The bearing assembly according to claim 1, wherein the bearing member includes:
an end surface axially opposed to the washer; and
an inclined surface arranged between the end surface and the bearing surface and inclined with respect to the center axis such that the inclined surface becomes closer to the center axis as it extends from the end surface toward the bearing surface; wherein
the shaft includes a corner portion on an outer side surface thereof between the annular groove and a portion thereof which is radially opposed to the bearing member; and
the corner portion of the shaft is radially opposed to the inclined surface of the bearing member.

9. The bearing assembly according to claim 1, wherein the shaft is provided with an axial support portion at a first axial end thereof, the axial support portion having an approximately semi-spherical surface; and a thrust member is arranged to be in contact with the axial support portion of the shaft.

10. The bearing assembly according to claim 1, further comprising:
a bearing support member having a hollow body and a bottom closing a first axial end of the hollow body, the hollow body being arranged to accommodate the bearing member therein;
a magnet chip arranged on the bottom of the bearing support member; and
an auxiliary yoke covering a bottom surface of the magnet chip; wherein
the auxiliary yoke includes the contact portion.

11. The bearing assembly according to claim 10, wherein the shaft is provided with an axial support portion at a first axial end thereof, the axial support portion having an approximately semi-spherical surface; and a thrust member is arranged to be in contact with the axial support portion of the shaft.

12. The bearing assembly according to claim 10, wherein the auxiliary yoke includes:
a hollow body covering the bottom surface of the magnet chip;
the contact portion extending radially outward from an end of the hollow body; and
a bent portion arranged between the hollow body and the contact portion; wherein
the hollow portion, the contact portion, and the bent portion of the auxiliary yoke are a single, unitary member.

13. The bearing assembly according to claim 12, wherein a recess is arranged at the bottom of the bearing support member to be concave at the first axial end;
the hollow body of the auxiliary yoke is accommodated in the recess; and
the contact portion is arranged at an open end of the recess in the axial direction.

14. The bearing assembly according to claim 1, further comprising a bearing support member including:
a hollow body and a bottom closing an end of the hollow body at a first end in the axial direction, the hollow body being arranged to accommodate the bearing member therein;
a concave recess provided at the bottom of the bearing support member; and
a flat surface extending in a radial direction substantially perpendicular to the center axis arranged between the recess and the hollow body of the bearing support member, the flat surface including the contact portion.

15. An electric motor comprising:
the bearing assembly according to claim 1;
a rotor portion arranged at an end of the shaft in the axial direction; and
a stator portion arranged to support the bearing assembly and generate a torque about the center axis by interaction with the rotor portion.

16. The bearing assembly according to claim 1, wherein the retaining member has a substantially annular shape or a substantially arcuate shape, and the washer has a substantially annular shape.
